(19) United States
(12) Patent Application Publication
(10) Pub. No.: US 2026/0366245 A1
(43) Pub. Date: Nov. 19, 2026

(54) ANTI-SLIP WALKING SURFACES

(71) Applicant: Sure-Foot Industries Corp., Cleveland, OH (US)

(72) Inventors: Brian Haas, North Royalton, OH (US); Terry Kelley, JR., North Olmsted, OH (US)

(21) Appl. No.: 19/679,234

(22) Filed: May 15, 2026

Related U.S. Application Data
(60) Provisional application No. 63/806,448, filed on May 15, 2025.

(51) Int. Cl. E01C 11/24; B32B 3/30

(52) U.S. Cl. CPC E01C 11/24; B32B 3/30; B32B 2255/26; B32B 2307/404; B32B 2307/7375; B32B 2307/744; B32B 2471/04; E01C 2201/18

(57) ABSTRACT

A walking surface is provided having a message presented thereon configured to be attached to a floor. The walking surface comprises a substrate comprising a first surface extending in a first plane and a second surface opposite the first surface, with the second surface extending in a second plane parallel to the first plane. The walking surface comprises section(s) positioned adjacent to the second surface of the substrate, and each section comprises a third surface extending parallel to the first plane. The walking surface comprises trench(es) extending from the third surface, with a base surface of trench(es) located between the first and second surfaces. The walking surface comprises a transparent or partially transparent coating positioned adjacent to the third surface of the section(s). Material at the third surface comprises a first color, and material at the base surface of the trench(es) comprises a second color different from the first color.

### CROSS-REFERENCE TO RELATED APPLICATIONS

This application claims priority to U.S. Provisional Patent Application No. 63/806,448, filed May 15, 2025, and entitled “Anti-Slip Walking Surfaces,” which is hereby incorporated by reference in its entirety for all purposes.

### FIELD

Embodiments relate generally to anti-slip walking surfaces that may be attached to a floor or another location to present messages.

### BACKGROUND

Steps and other walking surfaces are often provided with an anti-slip surface. These walking surfaces have been used to present messages. For example, these messages may be painted or otherwise colored directly on a floor. However, this often leads to the messages being worn out over time as people walk over these messages. Additionally, at locations where these messages are included, the coefficient of friction may be lower than at other locations on the floor, and this may lead to people potentially slipping and falling when walking over the portions of the walking surfaces having the messages.

### BRIEF SUMMARY

In various embodiments described herein, anti-slip walking surfaces are provided. These walking surfaces are configured to reduce the likelihood that individuals may slip and fall. The walking surfaces include one or more indicia (e.g., messages), and the indicia may include text, logos, images, or the like. A coating may be included in the walking surfaces to help protect the material used to form the indicia from wearing or fading over time, and the coating may also be used to provide an anti-slip surface. Additionally, the walking surfaces are designed so that a high amount of friction is provided even at locations where indicia are presented, thereby reducing the likelihood of any slipping.

The walking surfaces may be provided in the form of a tread or a panel, with the walking surfaces being configured to be positioned and/or attached on a floor. As such, the anti-slip nature of the coating used may be beneficial to prevent users from inadvertently slipping and falling when walking over the walking surfaces. Walking surfaces may be used in a factory, a kitchen, an office, on stairs, or at another location.

The walking surfaces may include a substrate having one or more trenches formed therein. A coating may cover the substrate and any other materials so that an exposed surface of the coating at locations proximate to trenches is offset by some distance from an exposed surface of the coating at locations away from the trenches. This offset may be beneficial to further enhance the amount of friction provided by the exposed surfaces of the coating.

In an example embodiment, a walking surface is provided having a message presented thereon configured to be attached to a floor. The walking surface comprises a substrate, one or more sections, one or more trenches, and a coating. The substrate comprises a first surface extending in a first plane. The substrate also comprises a second surface opposite the first surface, with the second surface extending in a second plane parallel to the first plane. The section(s) are positioned adjacent to the second surface of the substrate. Each section comprises a third surface extending parallel to the first plane. The trench(es) extend from the third surface such that a base surface of the trench(es) is located between the first surface and the second surface. The coating is positioned adjacent to the third surface of the section(s), and the coating is at least partially transparent. A first material at the third surface comprises a first color, a second material at the base surface of the trench(es) comprises a second color, and the second color is different from the first color.

In some embodiments, the coating may include a first portion positioned adjacent to the third surface of the section(s), and the coating may include a second portion positioned adjacent to a trench of the trench(es). The first portion may define a first coating surface facing away from the substrate, and the second portion may define a second coating surface facing away from the substrate. The first coating surface and the second coating surface may be offset by a distance in a direction normal to the first plane of the first surface. Additionally, in some embodiments, the distance may be between about 0.0025 inches and about 0.0625 inches.

In some embodiments, the second material in the trench(es) may form a message, and the message may comprise text, a logo, an image, a pattern, or symbols. In some embodiments, the coating may cause the walking surface to have an increased coefficient of friction relative to another walking surface without the coating that is otherwise identical to the walking surface. In some embodiments, the coating may comprise at least one of a resin, urethane, or an epoxy.

In some embodiments, the second material may be present in the substrate before the trench(es) are formed, and formation of the trench(es) may expose the second material. In some embodiments, the second material is not present in the substrate before the trench(es) are formed, and the second material may added in the trench(es) after the trench(es) are formed.

In some embodiments, the coating may be at least partially transparent to enable the first material and the second material to be seen. In some embodiments, the substrate may comprise at least one of fiberglass, polyethylene, a plastic, a polymer, aluminum, or a metal. In some embodiments, the trench(es) may be formed through use of a computer numerical control (CNC) machine. In some embodiments, the walking surface may be a tread or a panel. In some embodiments, the section(s) may comprise a material configured to increase a coefficient of friction for the walking surface relative to another walking surface without the section(s) that is otherwise identical to the walking surface.

In another example embodiment, a method is provided for forming a walking surface having a message presented thereon. The method comprises forming trench(es) in an assembly. The assembly comprises a substrate and an additional layer. The substrate comprises a first surface extending in a first plane, and the substrate comprises a second surface opposite the first surface with the second surface extending in a second plane parallel to the first plane. The additional layer is positioned adjacent to the second surface of the substrate, and the additional layer comprises a third surface facing away from the substrate. The trench(es) extend from the third surface so that a base surface of the trench(es) is located between the first surface and the second surface. The method also comprises positioning a coating relative to the assembly, and the coating is at least partially transparent. In the walking surface, a first material at the first surface of the substrate comprises a first color, a second material at the base surface of the trench(es) comprises a second color, and the second color is different from the first color.

In some embodiments, the coating may include a first portion positioned adjacent to the third surface of material from the additional layer, the coating may include a second portion positioned adjacent to a trench, the first portion may define a first coating surface facing away from the substrate, the second portion may define a second coating surface facing away from the substrate, and the first coating surface and the second coating surface may be offset by a distance in a direction normal to the first plane of the first surface.

In some embodiments, the method may also comprise positioning the second material at the base surface of the trench(es) after the trench(es) are formed in the substrate, and the coating may be positioned relative to the substrate after the second material has been positioned such that the coating covers the second material. In some embodiments, the second material may be present in the substrate before the trench(es) are formed, and the second material may become exposed after the trench(es) are formed. In some embodiments, the trench(es) may be formed through use of a computer numerical control (CNC) machine. In some embodiments, the additional layer may comprise a material configured to increase a coefficient of friction for the walking surface relative to another walking surface without the additional layer that is otherwise identical to the walking surface. In some embodiments, the second material in the trench(es) may form a message, and the message may comprise text, a logo, an image, a pattern, or symbols. In some embodiments, the walking surface may be a tread or a panel.

In another example embodiment, an article is provided that may have indicia presented thereon. The article comprises a multilayer assembly having at least one base layer and an additional layer above the base layer(s). The multilayer assembly has at least one trench defined therein in a pattern to provide predetermined indicia. The trench(es) extend completely through the additional layer and into the base layer(s). The article also comprises a coating layer applied above the additional layer and into the trench(es), with the coating layer being at least partially transparent. Material at a base surface of each trench of the trench(es) has a first color and the additional layer has a second color, with the first color being different from the second color.

### BRIEF DESCRIPTION OF THE DRAWINGS

Reference will now be made to the accompanying drawings, which are not necessarily drawn to scale, and wherein:

FIG. 1A is a schematic, top view illustrating an example walking surface having indicia comprising text presented on the walking surface, in accordance with some embodiments discussed herein;

FIG. 1B is a schematic, top view illustrating an example walking surface having indicia comprising a logo presented on the walking surface, in accordance with some embodiments discussed herein;

FIG. 1C is a schematic, top view illustrating an example walking surface having indicia comprising an image presented on the walking surface, in accordance with some embodiments discussed herein;

FIG. 2A is a schematic, cross-sectional view illustrating an example walking surface having trenches with colored material therein, in accordance with some embodiments discussed herein;

FIG. 2B is a schematic, cross-sectional view illustrating an example substrate used to form the walking surface of FIG. 2A, in accordance with some embodiments discussed herein;

FIG. 2C is a schematic, cross-sectional view illustrating an intermediate assembly where an anti-slip layer has been positioned relative to the substrate of FIG. 2B, in accordance with some embodiments discussed herein;

FIG. 2D is a schematic, cross-sectional view illustrating an intermediate assembly after material has been routed out of the intermediate assembly of FIG. 2C to form trenches, in accordance with some embodiments discussed herein;

FIG. 2E is a schematic, cross-sectional view illustrating the substrate of FIG. 2D after colored material has been positioned in the trenches of the substrate, in accordance with some embodiments discussed herein;

FIG. 2F is a schematic, cross-sectional view illustrating the walking surface that is formed after a coating has been positioned above the colored material and the substrate, with various dimensions for certain features of the walking surface being shown, in accordance with some embodiments discussed herein;

FIG. 3A is a schematic, cross-sectional view illustrating an example walking surface having trenches, with material at a base surface of the trenches having a different color other portions of the walking surface, in accordance with some embodiments discussed herein;

FIG. 3B is a schematic, cross-sectional view illustrating an example substrate used to form the walking surface of FIG. 3A, in accordance with some embodiments discussed herein;

FIG. 3C is a schematic, cross-sectional view illustrating an intermediate assembly where an anti-slip layer has been positioned relative to the substrate of FIG. 3B, with the anti-slip layer having a different color relative to the substrate, in accordance with some embodiments discussed herein;

FIG. 3D is a schematic, cross-sectional view illustrating an intermediate assembly after material has been routed out of the intermediate assembly of FIG. 3C to form trenches, in accordance with some embodiments discussed herein;

FIG. 3E is a schematic, cross-sectional view illustrating the walking surface that is formed after a coating has been applied, with various dimensions for certain features of the walking surface being shown, in accordance with some embodiments discussed herein;

FIG. 4 is a schematic, cross-sectional view illustrating an example walking surface with trenches having sidewalls that are tapered at an angle, in accordance with some embodiments discussed herein;

FIG. 5 is a schematic, cross-sectional view illustrating an example multi-layer assembly that may be used as a substrate to form a walking surface described herein, in accordance with some embodiments discussed herein;

FIG. 6 is a flow chart illustrating an example method for forming a multi-layer assembly, with this multi-layer assembly capable of being used as a substrate for forming walking surfaces, in accordance with some embodiments discussed herein; and

FIG. 7 is a flow chart illustrating an example method for forming walking surfaces, in accordance with some embodiments discussed herein.

### DETAILED DESCRIPTION

Example embodiments now will be described more fully hereinafter with reference to the accompanying drawings, in which some, but not all embodiments are shown. Like reference numerals generally refer to like elements throughout. For example, reference numerals 100A, 100B, 100C, 200, and 300 each refer to walking surfaces. Unless otherwise noted herein, a “message” may include text, a logo, an image, a pattern, symbols, or the like. Unless otherwise noted herein, “indicia” may include a message or some other representation.

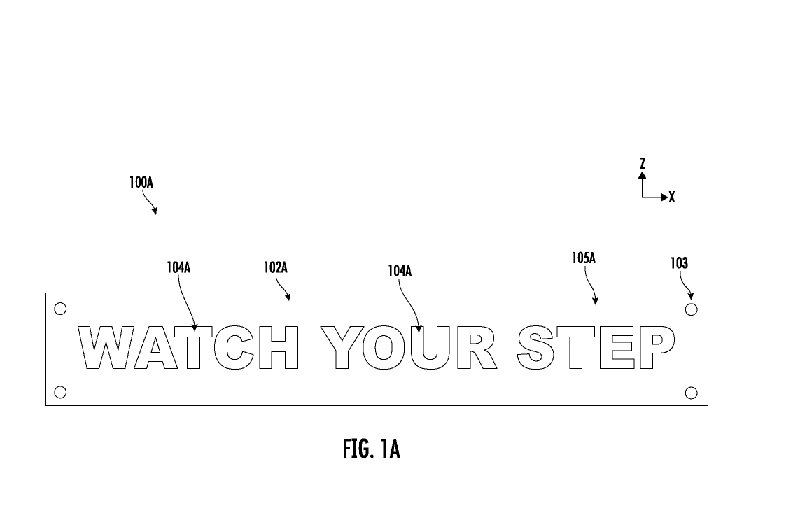

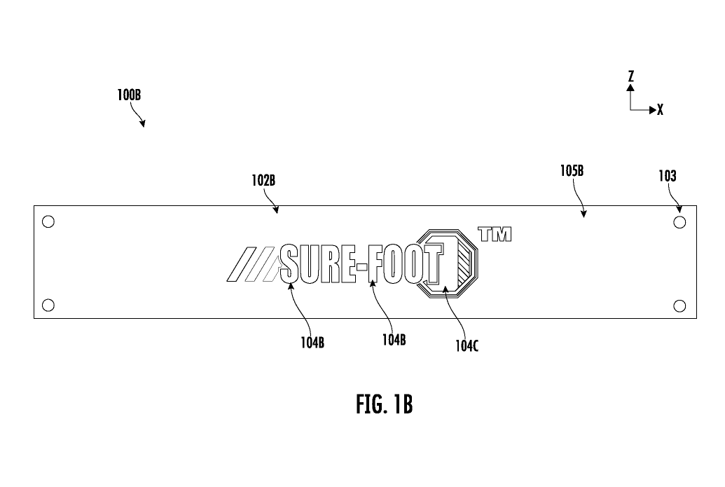

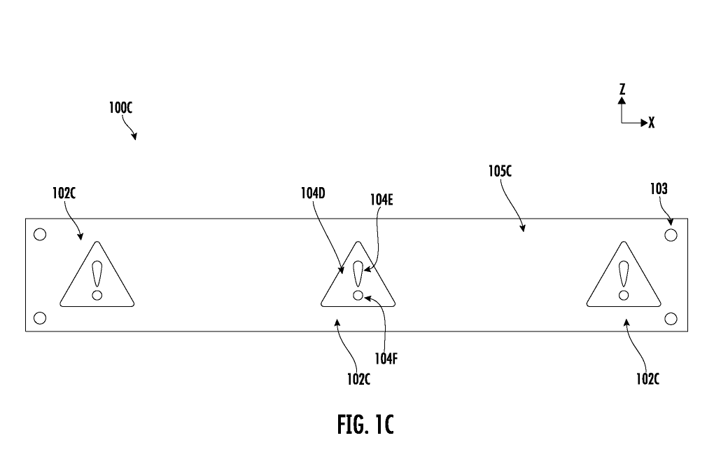

FIG. 1A is a schematic, top view illustrating an example walking surface 100A having indicia 102A presented thereon comprising text. The walking surface 100A includes a top surface 105A, with trenches 104A positioned in the walking surface 100A. The material located at the trenches 104A is provided in a first color (e.g., white), and the material located at the top surface 105A is provided in a second color (e.g., black) that is different from the first color. Thus, the material in the trenches may effectively form the indicia 102A, which comprises text. In the walking surface 100A, the text in the indicia 102A states “WATCH YOUR STEP.” However, other text may be used in other embodiments. Additionally, the colors used for the material at the trenches 104A and the material at the top surface 105A may be different in other embodiments. For example, the colors may be yellow, red, blue, green, gray or any other color.

The walking surface 100A also includes holes 103 therein, with the holes 103 being configured to receive fasteners therein so that the walking surface 100A may be attached to another surface. For example, the walking surface 100A and other walking surfaces described herein may be attached to a floor in a factory, a kitchen, an office, or at another location. Alternatively, the walking surface 100A and other walking surfaces described herein may be positioned on stairs, on a countertop, a desk, or at another location. In other embodiments, the holes 103 may be omitted. Adhesives may optionally be used in some embodiments to attach the walking surfaces to other surfaces. Fasteners such as tabs may be included on the walking surface 100A in some embodiments to facilitate alignment and/or attachment of the walking surface 100A. In some embodiments, both adhesives and fasteners may be used to attach walking surfaces described herein.

Walking surfaces may also be provided with other indicia including images (e.g., symbols), logos, and other content. For example, FIG. 1B illustrates another walking surface 100B having indicia 102B presented thereon, with the indicia 102B comprising a logo. The trenches 104B, 104C are positioned differently in the walking surface 100B so that the indicia 102B may effectively be formed. Additionally, in the walking surface 100B, material in a first trench 104B has a first color (e.g., yellow), material in a second trench 104C has a second color (e.g., red), and the two colors are different. Additionally, the material located at the top surface 105B is provided in a third color (e.g., black) that is different from the first color and the second color. In other embodiments, three or more colors may be used to present indicia in walking surfaces.

FIG. 1C illustrates a walking surface 100C having indicia 102C in the form of an image of a caution symbol presented thereon. The trench 104D comprises material of a first color (e.g., yellow), the surfaces 104E, 104F comprise material of a second color (e.g., black), and the material at the top surface 105C comprises material of a third color (e.g., black). The surface 105C and the surfaces 104E, 104F may be part of the same surface before the trench 104D is formed.

In various embodiments described herein, the walking surfaces may have a layer of coating positioned over the trenches to help prevent the indicia from being worn down or from fading over time. The coating material may be positioned over the trenches such that a top surface of the coating at the trenches is offset from the top surface of the coating at other locations in the walking surfaces, and this may enable the walking surfaces to effectively provide a greater amount of friction.

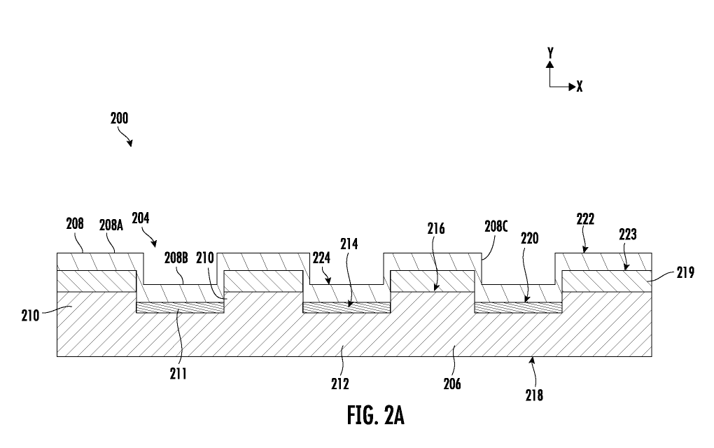

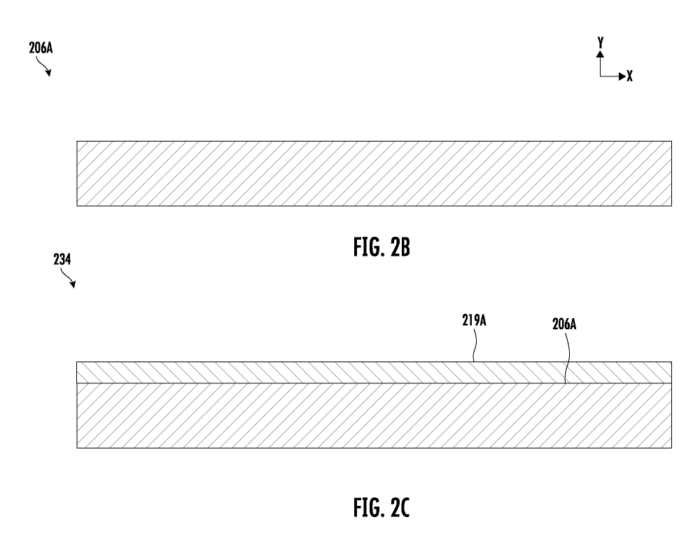

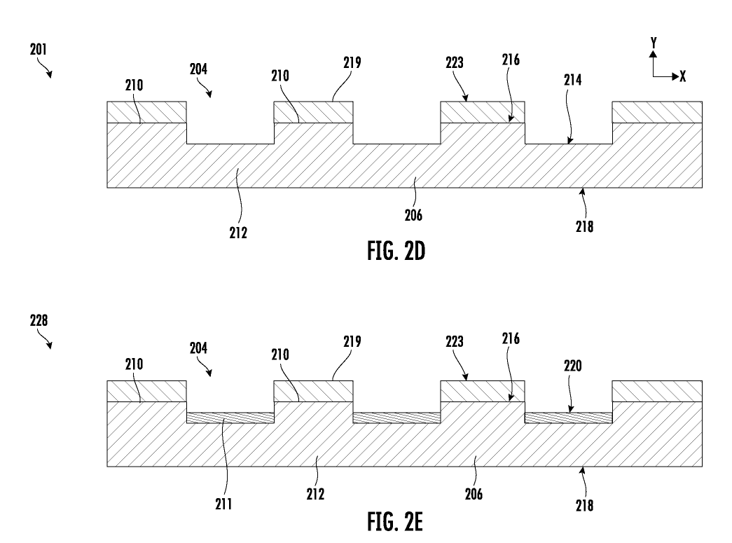

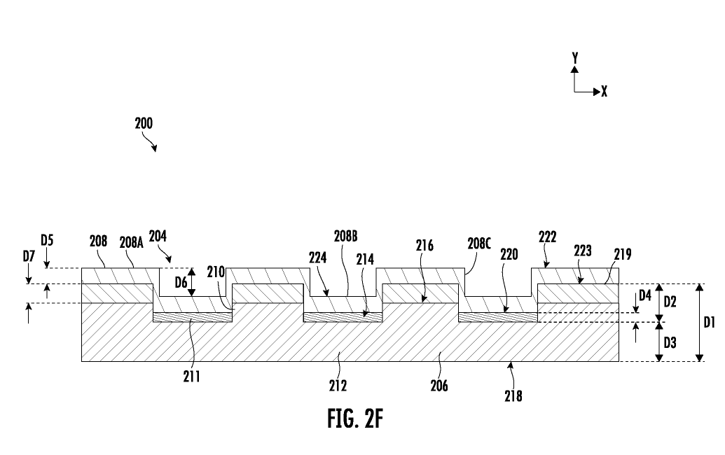

FIG. 2A is a schematic, cross-sectional view illustrating an example walking surface 200 having trenches 204 with a colored material 211 therein. The walking surface 200 includes a substrate 206. The substrate 206 comprises a base 212, which includes a base surface 218. The substrate 206 also includes a plurality of extended sections 210 that extend in the positive Y-direction relative to the base 212. The extended sections 210 comprise surfaces 216 extending parallel to the X-Z plane, and the surfaces 216 are the portions of the extended sections 210 positioned farthest in the positive Y-direction. The base surface 218 is positioned on an opposite side of the substrate 206 relative to the surfaces 216, and the base surface 218 extends parallel to the X-Z plane. The substrate 206 and other substrates described herein may comprise fiberglass, polyethylene (e.g., high density polyethylene (HDPE)), a plastic (e.g., a thermoplastic), aluminum, another metal, or a polymer, but the substrates may comprise other materials in other embodiments.

The walking surface 200 comprises anti-slip sections 219. These anti-slip sections 219 are positioned so that they are in contact with the surfaces 216 of the extended sections 210, and the anti-slip sections 219 comprise surfaces 223 extending parallel to the X-Z plane, and the surfaces 216 are the portions of the anti-slip sections 219 positioned farthest in the positive Y-direction. However, in other embodiments, walking surfaces may be provided without anti-slip sections—where this is the case, the coating 208 may be positioned against the surface 216 of the extended sections 210. The anti-slip sections 219 may comprise a material configured to increase a coefficient of friction for the walking surface 200 relative to another walking surface without the anti-slip sections 219 that is otherwise identical to the walking surface 200—this other walking surface may simply have the anti-slip sections 219 removed, with the coating 208 resting against the surfaces 216 of the extended sections 210.

The trenches 204 are defined in the substrate 206, with the trenches 204 positioned between the extended sections 210. Colored material 211 is positioned in the trenches 204. The colored material 211 may have a distinct color relative to the material at the surface 223 of the anti-slip sections 219. Thus, when a person is standing above the walking surface 200, the colors of the colored material 211 and the material at the surface 223 of the anti-slip sections 219 may have a contrast relative to each other, thereby allowing indicia to be easily seen. In some embodiments, the colored material 211 in the trenches 204 may form text for indicia when viewed from above. However, in other embodiments, the material at the surface 223 of the anti-slip sections 219 may form text for indicia when viewed from above, and the colored material 211 in the trenches 204 may form an outline around the text. The colored material 211 may be added by painting the material at the base surfaces 214 of trenches 204, by coloring the material at the base surfaces 214 of the trenches 204 by applying a colored material, by depositing material in the trenches 204 using one or more manufacturing processes (e.g., three-dimensional printing, spray coating, lamination, hot melt filling, injection molding, etc.), or by using another approach.

While the trenches 204 are illustrated as having the same shapes and the same depths, trenches 204 may have different shapes and/or sizes relative to each other in other embodiments. Additionally, while the extended sections 210 and anti-slip sections 219 are illustrated as having the same shapes and the same thicknesses, extended sections 210 and anti-slip sections 219 may have different shapes and/or sizes relative to each other in other embodiments.

The trenches 204 and other trenches described herein may be formed in a variety of ways. In some embodiments, these trenches may be formed using a computer numerical control (CNC) machine. The use of such a machine may be beneficial to form trenches with a high degree of precision and accuracy, and such a machine may beneficially form complex two-dimensional designs or three-dimensional designs for the trenches, allowing more complex indicia to be formed. A CNC machine may comprise a spindle, a worktable where a substrate may be secured, one or more processors, and one or more memory devices. The memory device(s) may include data therein regarding different properties for forming indicia in substrates, properties of substrates, properties of trenches, and other information. Additionally, the memory device(s) may comprise computer program code configured to, when executed by the processors, cause the processor to perform certain methods. For example, the computer program code may cause the processor to cause other components in the CNC machine (e.g., the spindle) to form the trenches so that the desired indicia may be formed. However, the CNC machine may comprise other components in some embodiments.

A coating 208 is positioned in the positive Y-direction relative to the substrate 206 and the anti-slip sections 219, with the coating 208 covering the extended sections 210, the anti-slip sections 219, and the colored material 211 within the trenches 204. The coating 208 comprises a first portion 208A, a second portion 208B, and a third portion 208C. The first portion 208A is positioned above the extended sections 210, and the second portion 208B is positioned above the base surface 214 of the trenches 204. The third portion 208C may connect the first portion 208A and the second portion 208B, with the third portion 208C effectively forming a sidewall extending along a direction parallel to the Y-Z plane. The coating 208 and other coatings described herein may be at least partially transparent to enable the colors in other materials covered by the coating 208 to be seen. While the coating 208 is illustrated with 90 degree edges, these edges may be chamfered or rounded in other embodiments. The coating 208 may cause the walking surface 200 to have an increased coefficient of friction relative to other walking surfaces without the coating (assuming that these other walking surfaces are otherwise identical to the walking surface 200, with only the coating 208 removed).

In some embodiments, additional material may be positioned in the trenches 204. This material may be positioned so that the material has a location along the Y-dimension that is between the surfaces 222 and the surfaces 224. This additional material may be tape (e.g., reflective tape, LED tape, etc.). However, other materials may be inserted in this space as well. In some embodiments, the additional material positioned in the trenches 204 may extend in the positive Y-dimension all the way up to the surfaces 222. In other embodiments, the additional material positioned in the trenches 204 may only partially fill up the remainder of the trenches 204 so that the material does not extend in the positive Y-dimension all the way up to the surfaces 222.

The walking surface 200 may be formed in a variety of ways, but FIGS. 2B–2E illustrate various stages in an example process flow for forming the walking surface 200. At the stage illustrated in FIG. 2B, an initial substrate 206A is provided. The initial substrate 206A is illustrated as having a single layer of material in FIG. 2B. However, in other embodiments, the initial substrate 206A may instead have multiple layers of different material similar to the multi-layer assembly 506A of FIG. 5.

At the stage illustrated in FIG. 2C, an intermediate assembly 234 is formed. The intermediate assembly 234 comprises an anti-slip layer 219A that has been positioned relative to the substrate 206A of FIG. 2B. The anti-slip layer 219A is positioned so that it is farther in the positive Y-direction than the substrate 206A. In some embodiments, the anti-slip layer 219A may have a color that is different from the substrate 206A. However, anti-slip layer 219A and the substrate 206A may share the same color in other embodiments.

At the stage illustrated in FIG. 2D, another intermediate assembly 201 is formed from the intermediate assembly 234. The intermediate assembly 201 comprises the substrate 206 and the anti-slip sections 219. To form the intermediate assembly 201, trenches 204 may be formed in the intermediate assembly 234 of FIG. 2C. These trenches 204 may be formed by removing material (e.g., by routing the material out or by removing in some other way) out of the initial substrate 206A and the anti-slip layer 219A of the intermediate assembly 234 of FIG. 2C (e.g., using a CNC machine). Once the trenches 204 are formed, the trenches 204 may be positioned between extended sections 210 of the substrate 206, with the extended sections 210 extending in the positive Y-direction relative to the base 212. Additionally, once the trenches 204 are formed, the trenches 204 may be positioned between anti-slip sections 219. However, some trenches 204 may be positioned at the edges of the intermediate assembly 201 such that they are not positioned between multiple extended sections 210.

At the stage illustrated in FIG. 2E, an intermediate assembly 228 is formed. The intermediate assembly 228 comprises the components of the intermediate assembly 201 of FIG. 2D and colored material 211. The colored material 211 is positioned in the trenches 204 of the substrate 206 to form the intermediate assembly 228. Thus, the colored material 211 is not included in the substrate 206 before the trenches 204 are formed, and the colored material 211 is only added in the trenches 204 after the trenches 204 are formed. The colored material 211 may have a distinct color relative to the material at the anti-slip sections 219, thereby providing contrast so that indicia may be presented.

At the stage illustrated in FIG. 2F, the walking surface 200 is illustrated after it has been fully formed. The walking surface 200 may be formed by positioning coating 208 above the colored material 211 and the substrate 206.

The walking surface 200 may possess various dimensions. The substrate 206 may extend a distance D1 between the base surface 218 and the surface 223, which is the farthest portion of the anti-slip sections 219 in the positive Y-direction. The distance D1 is measured in directions parallel to the Y-axis. In some embodiments, the distance D1 may be greater than about 0.1250 inches, about 0.1500 inches, about 0.2000 inches, about 0.2500 inches, or about 0.2750 inches. However, the distance D1 may possess other values in other embodiments. However, the distance D1 may have other values in other embodiments.

Together, the extended sections 210 and the anti-slip sections 219 may extend a distance D2 from the surface 223 to the base surfaces 214 of the trenches 204, with the distance D2 being measured in directions parallel to the Y-axis. Thus, the distance D2 may also define the depth of the trench 204. The base surfaces 214 may be positioned between the surface 223 and the base surface 218 in directions parallel to the Y-axis. Where the surface 223 is curved or possesses some other shape, the distance D2 may be measured between the farthest portion of the surface 223 in the positive Y-direction and the base surface 214. Where the base surface 214 is curved or possesses some other shape, the distance D2 may be measured between the farthest portion of the base surface 214 in the negative Y-direction and the surface 223.

In some embodiments, the distance D2 may be between 0 inches and about 0.0625 inches, between 0 inches and about 0.0500 inches, between 0 inches and about 0.0375 inches, between 0 inches and about 0.025 inches, and between about 0 inches and about 0.0125 inches. In some embodiments, the distance D2 may be defined in terms of a percentage of the distance D1. In some embodiments, D2 may be equal to between 0 percent and about 60 percent of D1, between 0 percent and about 50 percent of D1, between 0 percent and about 40 percent of D1, or between 0 percent and about 30 percent of D1. However, the distance D2 may have other values in other embodiments.

Additionally, the base 212 of the substrate 206 may extend a distance D3 between the base surface 218 and the base surface 214 of the trenches 204, with the distance D3 being measured in directions parallel to the Y-axis. Where the base surface 214 is curved or possesses some other shape, the distance D3 may be measured between the farthest portion of the base surface 214 in the negative Y-direction and the base surface 218.

The distance D3 may be equal to the distance D1 minus the distance D2. In some embodiments, the distance D3 may be between about 0.0625 inches and about 0.5000 inches, between about 0.0625 inches and about 0.2500 inches, between about 0.0625 inches and about 0.1250 inches, between about 0.0750 inches and about 0.1125 inches, between about 0.0875 inches and about 0.1000 inches. In some embodiments, the distance D3 may be defined in terms of a percentage of the distance D1. In some embodiments, D3 may be equal to between about 40 percent and 100 percent of D1, between about 50 percent and 100 percent of D1, between about 60 percent and 100 percent of D1, or between about 70 percent and 100 percent of D1. However, the distance D3 may have other values in other embodiments.

The colored material 211 may be positioned within the trenches 204 so that the colored material 211 extends a thickness, with this thickness being equal to the distance D4. The distance D4 may be measured in directions parallel to the Y-axis, with the distance D4 being measured between the exposed surface 220 of the colored material 211 and the base surface 214 of the trenches 204. The distance D4 may be between 0 inches and about 0.0625 inches, between 0 inches and about 0.0500 inches, between 0 inches and about 0.0375 inches, between 0 inches and about 0.025 inches, and between about 0 inches and about 0.0125 inches. However, the distance D4 may have other values in other embodiments.

The coating 208 may also be provided with a thickness, with this thickness being equal to the distance D5. The distance D5 may be measured in directions parallel to the Y-axis, with the distance D5 being measured between the surface 222 of the coating 208 and the surface 223 of the anti-slip sections 219. The thickness of the coating 208 between the surface 224 and the exposed surface 220 of the colored material 221 may be equal to the distance D5 in some embodiments. The distance D5 may be between 0 inches and about 0.0625 inches, between 0 inches and about 0.0500 inches, between 0 inches and about 0.0375 inches, between 0 inches and about 0.0250 inches, and between about 0 inches and about 0.0125 inches. However, the distance D5 may have other values in other embodiments.

When the walking surface 200 is fully assembled, the surface 222 of the coating 208 at the first portion 208A located proximate to the extended sections 210 may be offset by a distance D6 from the surface 224 of the coating 208 at the second portion 208B located proximate to the trenches 204, with the distance D6 being measured in directions parallel to the Y-axis (e.g., normal to the surface 222 or to the surface 223). The distance D6 may be between 0 inches and about 0.1000 inches, between 0.0025 inches and about 0.0750 inches, between 0. 0025 inches and about 0.0500 inches, between 0.0025 inches and about 0.0375 inches, between 0 inches and about 0.0250 inches, and between about 0.0025 inches and about 0.0125 inches. The distance D6 may be greater than the distance D5 in some embodiments. However, the distance D6 may have other values in other embodiments.

This offset distance D6 may be beneficial to further enhance the amount of friction provided by the exposed surfaces of the coating 208. In some embodiments, the coating 208 or other coatings described herein may comprise resin, urethane, epoxy, or other materials.

The anti-slip sections 219 also extend possess a thickness D7, with this thickness D7 being measured in directions parallel to the Y-axis. The thickness D7 is measured between the surface 223 and the surface 216 of the extended sections 210. The thickness D7 may be between 0 inches and about 0.2000 inches, between 0 inches and about 0.1000 inches, between 0 inches and about 0.0750 inches, between 0 inches and about 0.0375 inches, between 0 inches and about 0.0250 inches, and between about 0 inches and about 0.0125 inches. However, the thickness D7 may have other values in other embodiments.

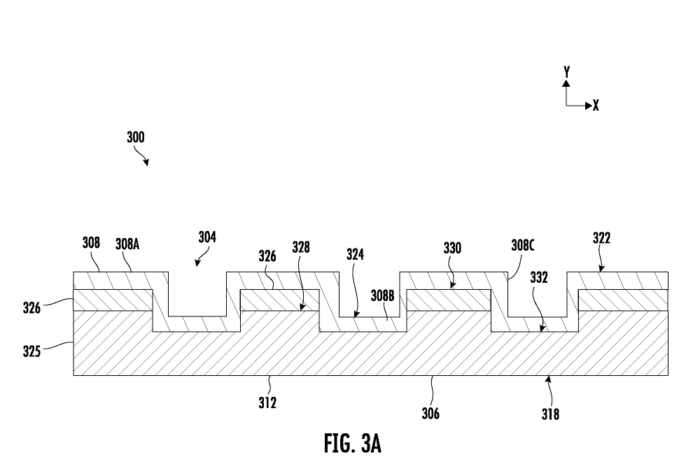

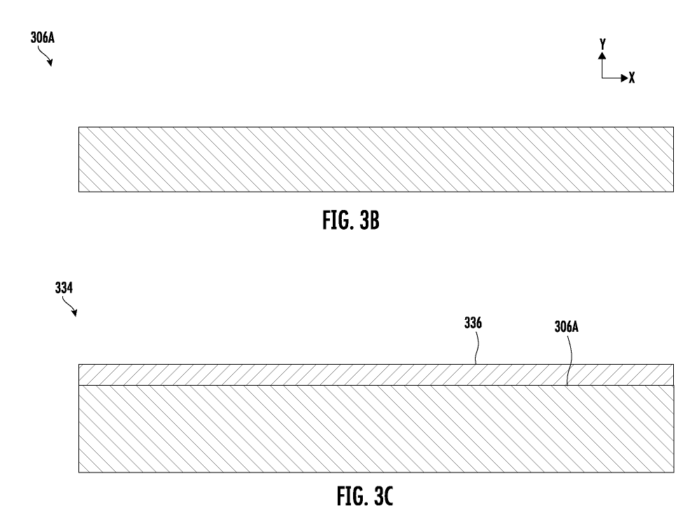

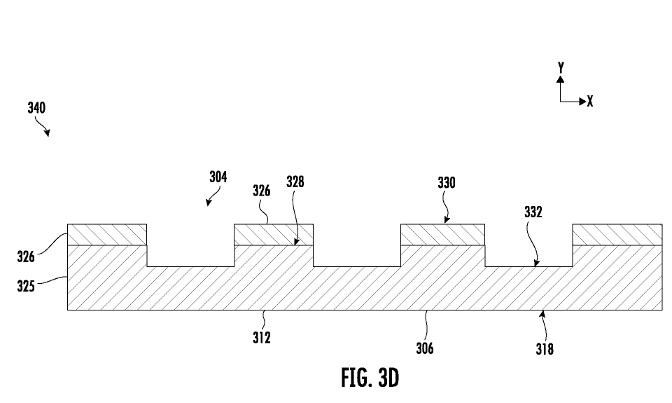

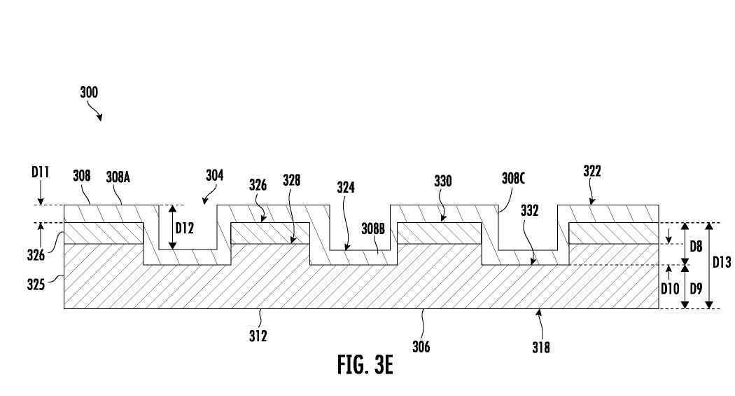

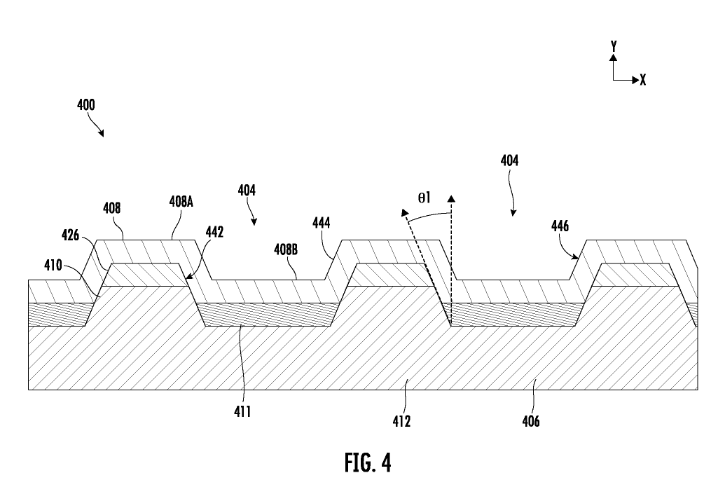

Another example walking surface 300 is illustrated in the schematic, cross-sectional view of FIG. 3A. The walking surface 300 has trenches 304, with material at a base surface 332 of the trenches 304 having a different color relative to other portions of the walking surface 300.

The walking surface 300 includes a substrate 306. The substrate 306 comprises a base 312, which includes a base surface 318. The substrate 306 also includes a plurality of extended sections 325 that extend in the positive Y-direction relative to the base 312.

The trenches 304 are defined in the substrate 306, with the trenches 304 positioned between the extended sections 325. Anti-slip sections 326 are positioned against the extended sections 325 of the substrate 306, with the anti-slip sections 326 being positioned farther in the positive Y-direction relative to the substrate 306. The material in the anti-slip sections 326 comprises a different color relative to the material in the substrate 306. Thus, when a person is standing above the walking surface 300, a contrast is present in the colors of the material at the anti-slip sections 326 relative to the colors of the material at the substrate 306, thereby allowing indicia to be easily seen. In some embodiments, the material of the substrate 306 that is visible at the trenches 304 may effectively form indicia, and the material at the anti-slip sections 326 may effectively form an outline around the indicia. However, in other embodiments, the material at the anti-slip sections 326 may effectively form indicia, and the material of the substrate 306 that is visible may effectively form an outline around the indicia. Alternatively, the material at the anti-slip sections 326 and the material of the substrate 306 may work together to effectively form indicia. While anti-slip sections 326 are included in the walking surface 300, walking surfaces may be provided without anti-slip sections in other embodiments—where this is the case, the coating 308 may be positioned against the surface 328 of the extended sections 325. The anti-slip sections 326 may comprise a material configured to increase a coefficient of friction for the walking surface 300 relative to another walking surface without the anti-slip sections 326 that is otherwise identical to the walking surface 300—this other walking surface may simply have the anti-slip sections 326 removed, with the coating 308 resting against the surfaces 328 of the extended sections 325.

A coating 308 is positioned in the positive Y-direction relative to the substrate 306, with the coating 308 covering the anti-slip sections 326 and the trenches 304. The coating 308 comprises a first portion 308A, a second portion 308B, and a third portion 308C. The first portion 308A is positioned above the anti-slip sections 326, and the second portion 308B is positioned above the base surface 332 of the trenches 304. The third portion 308C may connect the first portion 308A and the second portion 308B, with the third portion 308C effectively forming sidewalls that extend along a direction parallel to the Y-axis. While the coating 308 is illustrated with 90 degree edges, these edges may be chamfered or rounded in other embodiments. The coating 308 may cause the walking surface 300 to have an increased coefficient of friction relative to other walking surfaces without the coating (assuming that these other walking surfaces are otherwise identical to the walking surface 300, with only the coating 308 removed).

The walking surface 300 may be formed in a variety of ways, but FIGS. 3B–3E illustrate various stages in an example process flow for forming the walking surface 300. At the stage illustrated in FIG. 3B, an initial substrate 306A is provided. The initial substrate 306A is illustrated as having a single layer of material in FIG. 3B. However, in other embodiments, the initial substrate 306A may instead have multiple layers of different material similar to the multi-layer assembly 506A of FIG. 5.

At the stage illustrated in FIG. 3C, an intermediate assembly 334 is formed by positioning a layer of anti-slip material 336 relative to the initial substrate 306A of FIG. 3B. The layer of anti-slip material 336 comprises a different color relative to the initial substrate 306A, and the layer of anti-slip material 336 is positioned farther in the positive Y-direction relative to the initial substrate 306A. Thus, the material of the initial substrate 306A is present before the one or more trenches are formed, and formation of the one or more trenches exposes the second material in the initial substrate 306A so that indicia can be created due to a contrast in color between the material at the initial substrate 306A and the material at the layer of anti-slip material 336.

At the stage illustrated in FIG. 3D, an intermediate assembly 340 is formed from the intermediate assembly 334 of FIG. 3C. These trenches 304 may be formed by routing material out of the intermediate assembly 334, thereby removing material from the substrate 306A and the layer of anti-slip material 336. Once the trenches 304 are formed, the trenches 304 may be positioned between extended sections 325 of the substrate 306, with the extended sections 325 extending in the positive Y-direction relative to the base 312. However, some trenches 304 may be positioned at the edges of the substrate 306 such that they are not positioned between multiple extended sections 325.

At the stage illustrated in FIG. 3E, the walking surface 300 is illustrated after it has been fully formed. The walking surface 300 may be formed by positioning coating 308 above the anti-slip sections 326 and the substrate 306.

The walking surface 300 may possess various dimensions. The substrate 306 may extend a distance D13 between the base surface 318 and the surface 330, which is the farthest portion of the anti-slip sections 326 in the positive Y-direction. The distance D13 is measured in directions parallel to the Y-axis. In some embodiments, the distance D13 may be greater than about 0.1250 inches, about 0.1500 inches, about 0.2000 inches, about 0.2500 inches, or about 0.2750 inches. However, the distance D13 may have other values in other embodiments.

The surface 330 may be positioned a distance D8 away from the base surface 332 of the trenches 304, with the distance D8 being measured in directions parallel to the Y-axis. Where the surface 330 is curved or possesses some other shape, the distance D8 may be measured between the farthest portion of the surface 330 in the positive Y-direction and the base surface 332. Where the base surface 332 is curved or possesses some other shape, the distance D8 may be measured between the farthest portion of the base surface 332 in the negative Y-direction and the surface 330.

In some embodiments, the distance D8 may be between 0 inches and about 0.0625 inches, between 0 inches and about 0.0500 inches, between 0 inches and about 0.0375 inches, between 0 inches and about 0.025 inches, and between about 0 inches and about 0.0125 inches. In some embodiments, the distance D8 may be defined in terms of a percentage of the distance D13. In some embodiments, the distance D8 may be equal to between 0 percent and about 60 percent of the distance D13, between 0 percent and about 50 percent of the distance D13, between 0 percent and about 40 percent of the distance D13, or between 0 percent and about 30 percent of the distance D13. However, the distance D8 may have other values in other embodiments.

The base 312 of the substrate 306 may extend a distance D9 between the base surface 318 of the substrate 306 and the base surface 332 of the trenches 304, with the distance D9 being measured in directions parallel to the Y-axis. Where the surface 332 is curved or possesses some other shape, the distance D9 may be measured between the farthest portion of the surface 332 in the negative Y-direction and the surface 318. The distance D9 may be equal to the distance D13 minus the distance D8. In some embodiments, the distance D9 may be between about 0.0625 inches and about 0.5000 inches, between about 0.0625 inches and about 0.2500 inches, between about 0.0625 inches and about 0.1250 inches, between about 0.0750 inches and about 0.1125 inches, between about 0.0875 inches and about 0.1000 inches. In some embodiments, the distance D9 may be defined in terms of a percentage of the distance D13. In some embodiments, the distance D9 may be equal to between about 40 percent and 100 percent of the distance D13, between about 50 percent and 100 percent of the distance D13, between about 60 percent and 100 percent of the distance D13, or between about 70 percent and 100 percent of the distance D13. However, the distance D9 may have other values in other embodiments.

The extended sections 325 may extend a distance D10 beyond the base 312 in the positive Y-direction. The distance D10 may be measured in a direction parallel to the Y-axis, and the distance D10 may be measured between the surface 328 and the base surface 332. The surface 328 is the farthest portion of the extended sections 325 in the positive Y-direction. The distance D10 may be between 0 inches and about 0.0625 inches, between 0 inches and about 0.0500 inches, between 0 inches and about 0.0375 inches, between 0 inches and about 0.025 inches, and between about 0 inches and about 0.0125 inches. However, the distance D10 may have other values in other embodiments.

The coating 308 may also be provided with a thickness, with this thickness being equal to the distance D11. The distance D11 may be measured in directions parallel to the Y-axis, with the distance D11 being measured between the surface 322 of the coating and the surface 330 of the anti-slip sections 326. In some embodiments, the thickness of the coating 308 at the second portion 308B may also be equal to the distance D11. The distance D11 may be between 0 inches and about 0.0625 inches, between 0 inches and about 0.0500 inches, between 0 inches and about 0.0375 inches, between 0 inches and about 0.025 inches, and between about 0 inches and about 0.0125 inches. However, the distance D11 may have other values in other embodiments.

When the walking surface 300 is fully assembled, the surface 322 of the coating 308 at the first portion 308A may be offset by a distance D12 from the surface 324 of the coating 308 at the second section 308B, with the distance D12 being measured in directions parallel to the Y-axis. The distance D12 may be between 0 inches and about 0.0625 inches, between 0.0025 inches and about 0.0500 inches, between 0.0025 inches and about 0.0375 inches, between 0.0025 inches and about 0.025 inches, and between about 0.0025 inches and about 0.0125 inches. However, the distance D12 may have other values in other embodiments. This offset distance D12 may be beneficial to further enhance the amount of friction provided by the exposed surfaces of the coating 308.

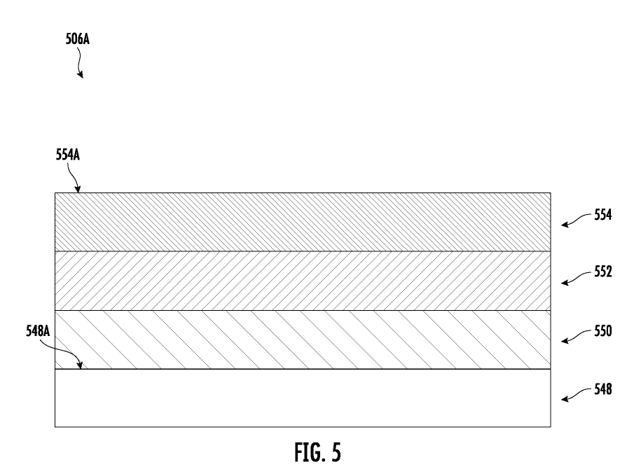

Another example walking surface 400 with trenches 404 having third portions 444 (e.g., sidewalls) that are tapered at an angle ϴ1 is illustrated in FIG. 4. Similar to other embodiments, the walking surface comprises a substrate 406, with the substrate 406 including a base 412 and extended sections 410. Additionally, anti-slip sections 426 are positioned adjacent to the extended sections 410, with the extended sections 410 positioned farther in the positive Y-direction relative to the anti-slip sections 426. Trenches 404 are formed in the substrate 406 between the extended sections 410. However, some trenches 404 may be positioned at the edges of the substrate 406 such that they are not positioned between multiple extended sections 410. Additionally, the walking surface 400 comprises a coating 408, with the coating 408 including a first portion 408A, a second portion 408B, and a third portion 444 in the form of a sidewall.

Colored material 411 is positioned in the trench 404. The third portions 444 include angled surfaces 442, with these angled surfaces 442 extending at an angle ϴ1. This angle ϴ1 may possess a wide variety of different values. For example, the angle ϴ1 may be between about 0 and about 75 degrees, between about 0 and about 60 degrees, between about 0 and about 45 degrees, between about 0 and about 30 degrees and between about 0 and about 20 degrees. However, other values may be used for the angle ϴ1. In the embodiment illustrated in FIG. 4, the angled surfaces 442 each possess a straight cross-sectional shape in the illustrated cross-section. However, the angled surfaces 442 may each possess a curved shape (e.g., concave or convex shape) or some other shape in other embodiments. The coating 408 may also include surfaces 446 extending at an angle. The angle that surfaces 446 extend at may be equal to or similar to the angle ϴ1. By including angled surfaces 442, the indicia formed on the walking surface 400 may potentially be visible from a wider range of angles.

While the initial substrate used in other embodiments is illustrated with only one material throughout the substrate, other substrates comprising multiple materials may be used in place of this initial substrate. For example, FIG. 5 illustrates an example multi-layer assembly 506A that may be used as substrate, and this multi-layer assembly may be used to form a walking surface described herein. The multi-layer assembly 506A comprises a first layer 548, a second layer 550, a third layer 552, and a fourth layer 554. The size and/or thickness of these layers 548, 550, 552, 554 are not drawn to scale.

The first layer 548 may comprise a base material. This base material may comprise fiberglass, polyethylene, or another material. Before other layers are positioned relative to the first layer 548, the first layer 548 may be run through a sander machine that may be configured to remove material from the surface 548A of the first layer 548. The sander machine may comprise sandpaper or another contact surface having a sandpaper-like surface, and the sander machine may include one or more actuators that may move the sandpaper or the other contact surface against the surface 548A. However, the sander machine may be different in other embodiments. By running the first layer 548 through the sander machine, the first layer 548 may have increased adhesion so that it can better adhere to other layers. After being run through the sander machine, excess material (e.g., sanding dust) may be removed. This may be done to allow the first layer 548 to better adhere to other layers. Excess material may be removed by using high pressure water or compressed air in some embodiments, but other approaches may also be used.

The second layer 550 may be positioned relative to the first layer. In some embodiments, the second layer 550 may be positioned relative to the first layer 548 after the first layer 548 has been run through a sander machine and after any excess material has been removed. In some embodiments, the second layer 550 may comprise a resin material, but the second layer 550 may comprise other materials in other embodiments.

The third layer 552 may then be positioned relative to the second layer 550. The third layer 552 may comprise a grit material. This grit material may be a clear or colored product, with the grit material having particles configured to pass through a mesh having a mesh size between 8-70 mesh such that the particles fit through a mesh having between 8 openings per square inch and 70 openings per square inch.

The grit material may be added to provide a heavy duty, medium, or lite surface texture. For example, the grit material may have a larger particle size to enable a heavy duty surface texture, the grit material may have a smaller particle size to enable a lite surface texture, and the grit material may have a medium particle size to enable a medium surface texture.

The third layer of material 552 may be added by placing the first layer 548 and the second layer 550 on a belt, and grit material may be added to these layers 548, 550 as part of a grit application process while these layers 548, 550 are on the belt. After the third layer of material 552 is applied, the layer 552 may be cured for a certain period of time (e.g., three hours, four hours, twelve hours, one day, multiple days, etc.) before positioning any additional layers.

A fourth layer 554 may then be positioned relative to the third layer 552. The fourth layer 554 may comprise a coating material that is configured to encapsulate the grit particles of the third layer 552.

In some embodiments, the material at a surface 554A of the fourth layer 554 may have a color that is different from the color of the material included in one of the other layers. Thus, when material is removed from the multi-layer assembly 506A to form trenches, the material at the bottom of the trenches may be different from the material at the surface 554A, thereby providing the contrast needed to make particular indicia visible. This may be accomplished without the use of further coloring material, which may potentially make the process more cost efficient.

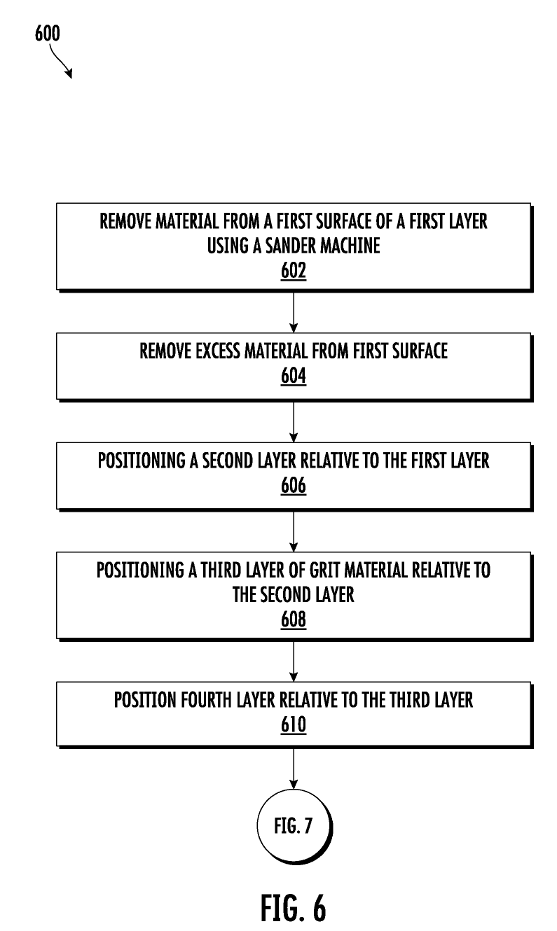

Various methods are also contemplated herein for the formation of walking surfaces. FIG. 6 is a flow chart illustrating an example method 600 for forming a multi-layer assembly, and this multi-layer assembly may be used as the substrate to form walking surfaces in some embodiments. The multi-layer assembly may be similar to the multi-layer assembly 506A of FIG. 5.

At operation 602, material may be removed from a first surface of a first layer using a sander machine. The first layer may comprise fiberglass, polyethylene, a plastic, a polymer, aluminum, another metal, or another material. By using the sander machine to remove the material, the first surface may have improved adhesion (relative to when the first surface is not run through a sander machine).

At operation 604, excess material may be removed from the first surface. This excess material may be removed by wiping the surfaces, and water, isopropyl alcohol, or another fluid may be used to help remove the excess material from the surface. By removing the excess material, any excess sanding dust that is left after running the first layer through the sanding machine may be removed to prevent this excess sanding dust from negatively impacting adhesion of the first layer with other layers.

At operation 606, a second layer may be positioned relative to the first layer. The second layer may comprise a resin material, but the second layer may comprise other types of materials in other embodiments. In some embodiments, the second layer may include a single material. However, in other embodiments, the second layer may comprise two or more portions, and the portions may optionally comprise different materials (e.g., two different types of resin materials).

At operation 608, a third layer comprising grit material may be positioned relative to the second layer. This may be accomplished by placing the intermediate assembly formed through operation 606 on a conveyor belt, with the conveyor belt moving the intermediate assembly along so that a grit application process may be performed to position the third layer relative to the second layer. The grit material may comprise a clear crush glass product having properties similar to those described herein in reference to the third layer 552 of FIG. 5.

In some embodiments, the intermediate assembly formed through operation 608 may be allowed to cure for a certain period of time before proceeding to operation 610. For example, the intermediate assembly may be allowed to cure for a time period of about 1 hour or more, about 3 hours or more, about 4 hours or more, about 12 hours or more, about one day, or multiple days.

At operation 610, a fourth layer is positioned relative to the third layer. The fourth layer may be a coating layer that effectively encapsulates in the grit material of the third layer.

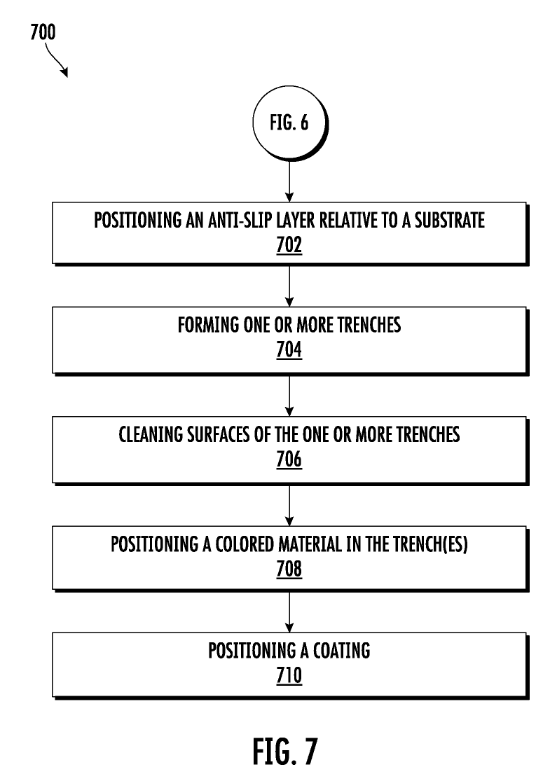

FIG. 7 is a flow chart illustrating an example method 700 for forming a walking surface. In some embodiments, the substrate used in method 700 may be the multi-layer assembly formed using the method 600 illustrated in FIG. 6. However, another substrate may be used in the method 700 instead of the multi-layer assembly generated by method 600.

At operation 702, a layer of anti-slip material may be positioned relative to a substrate. Where the substrate is the multi-layer assembly formed using the method 600 illustrated in FIG. 6, operation 702 may optionally be omitted. However, a layer of anti-slip material may be added to the multi-layer assembly in some embodiments at operation 702.

At operation 704, one or more trenches are formed. The trench(es) may be formed using a CNC machine in some embodiments, with these machines being configured to form the trench(es) with a high degree of precision. The trenches may be formed in the layer of anti-slip material and in the substrate. For any trenches that are formed, the trenches may extend from a surface of the anti-slip layer towards a surface of the substrate (e.g., a bottom surface) such that a base surface of the one or more trenches is located between the surface of the anti-slip layer and the surface of the substrate (e.g., the bottom surface) in a direction normal to these surfaces.

At operation 706, the surfaces of the trench(es) may be cleaned. This may be accomplished by using high pressure water or compressed air. However, the surfaces may be cleaned in other ways.

At operation 708, a colored material may optionally be added in the trench(es). This colored material may provide contrast relative to other portions of the walking surface. In some embodiments, the colored material may be added by painting the colored material into the trench(es), or by depositing the colored material in some other manner. However, in some embodiments, operation 708 may be omitted. For example, where the substrate has different colored materials therein or where a colored material has been added before the formation of trenches, the formation of trenches may cause the different colored material to be exposed, thereby allowing indicia to be formed. The colored material or any other material included in the trenches may have a different color relative to the material at the first surface of the substrate.

At operation 710, a coating is positioned relative to the substrate, the anti-slip layer, and the colored material. The coating may comprise a clear epoxy, but the coating may comprise other types of materials in other embodiments. In some embodiments, the coating may include a single material. However, in other embodiments, the coating may comprise two or more portions, and the portions may optionally comprise different materials (e.g., two different types of epoxy materials). After the coating is positioned, the walking surface may be allowed to cure for a certain period of time (e.g., 30 minutes or more, 1 hour or more, 2 hours or more, 3 hours or more, 1 day, multiple days, etc.). Operation 708 may be performed after operations 702, 704, 706 so that the coating covers the second material.

As noted here, after the coating is positioned relative to the substrate, the surfaces of the coating facing away from the substrate may be uneven, with surfaces positioned proximate to trenches being offset relative to surfaces positioned at other locations away from the trenches in directions normal to the surface of the first surface of the substrate.

While various methods are described herein, these methods are merely exemplary. In other embodiments contemplated herein, the methods may be modified so that the operations are performed in different orders. Additionally or alternatively, some of the operations may be performed simultaneously in some embodiments. Furthermore, one or more of the operations that are illustrated may be omitted in some embodiments, and additional operations may be added. The methods described herein may also be combined together. For example, the method 600 may be combined together with the method 700.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A walking surface having a message presented thereon configured to be attached to a floor, the walking surface comprising:
a substrate comprising:
a first surface extending in a first plane,
a second surface opposite the first surface, the second surface extending in a second plane parallel to the first plane,
one or more sections positioned adjacent to the second surface of the substrate, wherein each of the one or more sections comprises:
a third surface extending parallel to the first plane;
one or more trenches extending from the third surface such that a base surface of the one or more trenches is located between the first surface and the second surface; and
a coating positioned adjacent to the third surface of the one or more sections, wherein the coating is at least partially transparent,
wherein a first material at the third surface comprises a first color, a second material at the base surface of the one or more trenches comprises a second color, and the second color is different from the first color.

2. The walking surface of claim 1, wherein the coating includes a first portion positioned adjacent to the third surface of the one or more sections, the coating includes a second portion positioned adjacent to a trench of the one or more trenches, the first portion defines a first coating surface facing away from the substrate, the second portion defines a second coating surface facing away from the substrate, and the first coating surface and the second coating surface are offset by a distance in a direction normal to the first plane of the first surface.

3. The walking surface of claim 2, wherein the distance is between about 0.0025 inches and about 0.0625 inches.

4. The walking surface of claim 1, wherein the second material in the one or more trenches forms a message, and the message comprises text, a logo, an image, a pattern, or symbols.

5. The walking surface of claim 1, wherein the coating causes the walking surface to have an increased coefficient of friction relative to another walking surface without the coating that is otherwise identical to the walking surface.

6. The walking surface of claim 1, wherein the coating comprises at least one of a resin, urethane, or an epoxy.

7. The walking surface of claim 1, wherein the second material is present in the substrate before the one or more trenches are formed, and formation of the one or more trenches exposes the second material.

8. The walking surface of claim 1, wherein the second material is not present in the substrate before the one or more trenches are formed, and the second material is added in the one or more trenches after the one or more trenches are formed.

9. The walking surface of claim 1, wherein the substrate comprises at least one of fiberglass, polyethylene, a plastic, a polymer, aluminum, or a metal.

10. The walking surface of claim 1, wherein the one or more trenches are formed through use of a computer numerical control (CNC) machine.

11. The walking surface of claim 1, wherein the walking surface is a tread or a panel.

12. The walking surface of claim 1, wherein the one or more sections comprise a material configured to increase a coefficient of friction for the walking surface relative to another walking surface without the one or more sections that is otherwise identical to the walking surface.

13. A method for forming a walking surface having a message presented thereon, the method comprising:
forming one or more trenches in an assembly, wherein the assembly comprises a substrate and an additional layer, the substrate comprises a first surface extending in a first plane, the substrate comprises a second surface opposite the first surface with the second surface extending in a second plane parallel to the first plane, the additional layer is positioned adjacent to the second surface of the substrate, the additional layer comprising a third surface facing away from the substrate, and the one or more trenches extend from the third surface so that a base surface of the one or more trenches is located between the first surface and the second surface; and
positioning a coating relative to the assembly, wherein the coating is at least partially transparent,
wherein a first material at the first surface of the substrate comprises a first color, a second material at the base surface of the one or more trenches comprises a second color, and the second color is different from the first color.

14. The method of claim 13, wherein the coating includes a first portion positioned adjacent to the third surface of material from the additional layer, the coating includes a second portion positioned adjacent to a trench of the one or more trenches, the first portion defines a first coating surface facing away from the substrate, the second portion defines a second coating surface facing away from the substrate, and the first coating surface and the second coating surface are offset by a distance in a direction normal to the first plane of the first surface.

15. The method of claim 13, further comprising:
positioning the second material at the base surface in the one or more trenches after the one or more trenches are formed in the substrate,
wherein the coating is positioned relative to the substrate after the second material has been positioned such that the coating covers the second material.

16. The method of claim 13, wherein the second material is present in the substrate before the one or more trenches are formed, and the second material becomes exposed after the one or more trenches are formed.

17. The method of claim 13, wherein the one or more trenches are formed through use of a computer numerical control (CNC) machine.

18. The method of claim 13, wherein the additional layer comprises a material configured to increase a coefficient of friction for the walking surface relative to another walking surface without the additional layer that is otherwise identical to the walking surface.

19. The method of claim 13, wherein the second material in the one or more trenches forms a message, and the message comprises text, a logo, an image, a pattern, or symbols.

20. An article comprising:
a multilayer assembly having at least one base layer and an additional layer above the at least one base layer, the multilayer assembly having at least one trench defined therein in a pattern to provide predetermined indicia, the at least one trench extending completely through the additional layer and into the at least one base layer; and
a coating layer applied above the additional layer and into the at least one trench, the coating layer being at least partially transparent,
wherein material at a base surface of each trench of the at least one trench has a first color and the additional layer has a second color, the first color being different from the second color.
